(19) United States
(12) Patent Application Publication
(10) Pub. No.: US 2024/0389162 A1
(43) Pub. Date: Nov. 21, 2024

(54) SYSTEMS, METHODS, AND NON-TRANSITORY COMPUTER-READABLE MEDIA FOR TRANSMISSION MODE SWITCHING

(71) Applicant: ZTE Corporation, Shenzhen (CN)

(72) Inventors: Xing LIU, Shenzhen (CN); Xianghui HAN, Shenzhen (CN); Junfeng ZHANG, Shenzhen (CN); Jing SHI, Shenzhen (CN)

(73) Assignee: ZTE Corporation, Shenzhen (CN)

(21) Appl. No.: 18/788,205

(22) Filed: Jul. 30, 2024

Related U.S. Application Data
(63) Continuation of application No. PCT/CN2022/109790, filed on Aug. 2, 2022.

(51) Int. Cl. H04W 74/0833; H04W 72/1268; H04W 72/23

(52) U.S. Cl. CPC H04W 74/0833; H04W 72/1268; H04W 72/23

(57) ABSTRACT

Arrangements disclosed herein relate to dynamic mode switching, including receiving, by a User Equipment (UE) from a network, at least one of a first indication or a second indication. The at least one of the first indication and second indication indicates a transmission parameter for uplink transmission. The second indication indicates that a relationship between the transmission parameter and the first indication. The transmission parameter includes transform precoder configuration. The UE sends to the network the uplink transmission using the transmission parameter as indicated by the at least one of the first indication or the second indication.

### CROSS-REFERENCE TO RELATED APPLICATION

This application claims the benefit of priority under 35 U.S.C. § 120 as a continuation of International Patent Application No. PCT/CN2022/109790, filed on Aug. 2, 2022, the disclosure of which is incorporated herein by reference in its entirety.

### TECHNICAL FIELD

The disclosure relates generally to wireless communications and, more particularly, to systems, methods, and non-transitory computer-readable media for transmission mode switching.

### BACKGROUND

Although wireless communication services cover increasingly more applications, conventional wireless communication services do not align with communication frequency bands. For some systems, frequency bands are high relative to the service, resulting in greater loss in propagation. The cell coverage radius is relatively small under the same power.

### SUMMARY

The example implementations disclosed herein are directed to solving the issues relating to one or more of the problems presented in the prior art, as well as providing additional features that will become readily apparent by reference to the following detailed description when taken in conjunction with the accompany drawings. In accordance with various implementations, example systems, methods, devices and computer program products are disclosed herein. It is understood, however, that these implementations are presented by way of example and are not limiting, and it will be apparent to those of ordinary skill in the art who read the present disclosure that various modifications to the disclosed implementations can be made while remaining within the scope of this disclosure.

Some arrangements of the present disclosure relate to systems, apparatuses, methods, and non-transitory computer-readable media for indicating transform precoder configuration, including receiving, by a User Equipment (UE) from a network (e.g., a Base Station (BS)), at least one of a first indication or a second indication. The at least one of the first indication and second indication indicates a transmission parameter for uplink transmission. The second indication indicates that a relationship between the transmission parameter and the first indication, and the transmission parameter includes transform precoder configuration. The UE sends to the network the uplink transmission using the transmission parameter as indicated by the at least one of the first indication or the second indication.

Some arrangements of the present disclosure relate to systems, apparatuses, methods, and non-transitory computer-readable media for indicating transform precoder configuration, including sending, by a network to a UE, at least one of a first indication or a second indication, the at least one of the first indication or the second indication indicating that a transmission parameter for uplink transmission. The second indication indicates that the relationship between the transmission parameter and the first indication, and the transmission parameter includes transform precoder configuration. The network receives from the UE the uplink transmission using the transmission parameter as indicated by the at least one of the first indication or the second indication.

The above and other aspects and their implementations are described in greater detail in the drawings, the descriptions, and the claims.

### BRIEF DESCRIPTION OF THE DRAWINGS

Various example implementations of the present solution are described in detail below with reference to the following figures or drawings. The drawings are provided for purposes of illustration only and merely depict example implementations of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network, according to some arrangements.

FIG. 2 illustrates block diagrams of an example base station and an example user equipment device, according to some arrangements.

FIG. 3 is a table illustrating example relationships between Radio Resource Control (RRC) parameters or fields and applicable Physical Uplink Shared Channel (PUSCH), according to some arrangements.

FIG. 4 is a flowchart diagram illustrating an example method for indicating transform precoder configuration, according to various arrangements.

FIG. 5 is a diagram illustrating time-domain restrictions for dynamic switching of uplink transmission parameters (e.g., transform precoder configuration), according to various arrangements.

FIG. 6 is a diagram illustrating time-domain restrictions for dynamic switching of uplink transmission parameters (e.g., transform precoder configuration), according to various arrangements.

### DETAILED DESCRIPTION

Various example implementations of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example implementations and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

Mobile communication systems can be systematically networked on carrier frequencies higher than those used in 2G, 3G, and 4G systems. Some systems utilize frequency bands of 3 GHZ to 6 GHz, 6 GHz to 100 GHz, and so on. In these systems, frequency bands are high relative to the service, resulting in greater loss in propagation. The cell coverage radius is relatively small under the same power. To implement broader range of communication systems, including but not limited to 2G, 3G, and 4G, some arrangements herein relate to enhancing coverage for uplink channels, such as Physical Uplink Shared Channel (PUSCH), Physical Uplink Control Channel (PUCCH), and so on.

In some implementations, two waveforms are supported in uplink, Discrete Fourier Transform (DFT) spread Orthogonal Frequency Division Multiplexing (OFDM) (DFT-s-OFDM) and Cyclic Prefix (CP) OFDM (CP-OFDM). DFT-s-OFDM supports single-layer transmissions while CP-OFDM supports multi-layer uplink transmissions. When the UE is at a cell edge, DFT-s-OFDM waveforms provide superior coverage due to power efficiency. However, network semi-statically configures waveforms for uplink transmission, meaning that a UE which supports multiple transmission antennas supports only single-layer transmissions if configured with DFT-s-OFDM waveform. Therefore, the network configures CP-OFDM waveforms for uplink transmissions to exploit uplink Multiple Input Multiple Output (MIMO) transmissions. Currently, the waveforms used in uplink are configured via Radio Resource Control (RRC) signaling and cannot be dynamically switched, resulting in difficulties in switching over to DFT-s-OFDM waveforms for cell-edge UEs. Some arrangements relate to implementing dynamic switching between different waveforms for uplink transmissions.

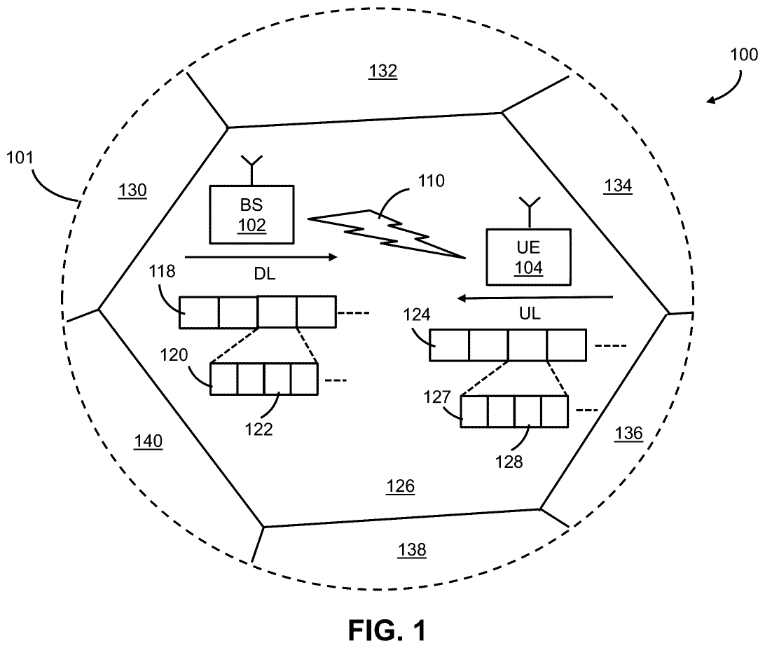

FIG. 1 illustrates an example wireless communication network, and/or system, 100 in which techniques disclosed herein may be implemented, in accordance with an implementation of the present disclosure. In the following discussion, the wireless communication network 100 may be any wireless network, such as a cellular network or a narrowband Internet of things (NB-IoT) network, and is herein referred to as network 100. Such an example network 100 includes a BS 102 and a UE 104 that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one BS operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various implementations of the present solution.

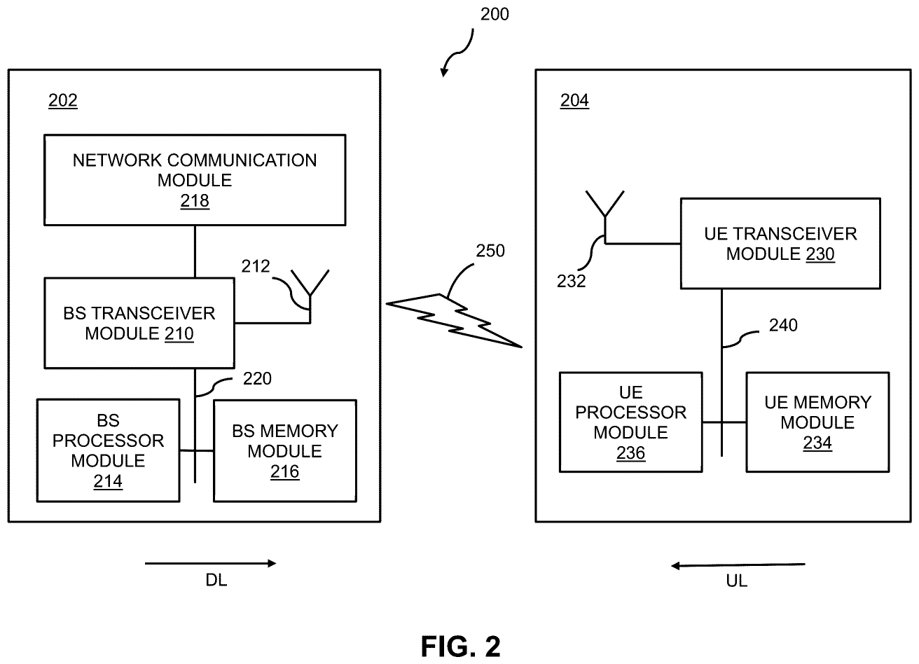

FIG. 2 illustrates a block diagram of an example wireless communication system 200 for transmitting and receiving wireless communication signals, e.g., OFDM/OFDMA signals, in accordance with some implementations of the present solution. The system 200 may include components and elements configured to support known or conventional operating features that need not be described in detail herein. In one illustrative implementation, system 200 can be used to communicate (e.g., transmit and receive) data symbols in a wireless communication environment such as the wireless communication environment 100 of FIG. 1, as described above.

System 200 generally includes a BS 202 and a UE 204. The BS 202 includes a Base Station (BS) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the implementations disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some implementations, the UE transceiver 230 may be referred to herein as an uplink transceiver 230 that includes a radio frequency (RF) transmitter and a RF receiver each including circuitry that is coupled to the antenna 232. A duplex switch (not shown) may alternatively couple the uplink transmitter or receiver to the uplink antenna in time duplex fashion. Similarly, in accordance with some implementations, the BS transceiver 210 may be referred to herein as a “downlink” transceiver 210 that includes a RF transmitter and a RF receiver each including circuitry that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some implementations, there is close time synchronization with a minimal guard time between changes in duplex direction.

The UE transceiver 230 and the BS transceiver 210 are configured to communicate via the wireless data communication link 250, and cooperate with a suitably configured RF antenna arrangement 212/232 that can support a particular wireless communication protocol and modulation scheme. In some illustrative implementations, the UE transceiver 210 and the BS transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the BS transceiver 210 may be configured to support alternate, or additional, wireless data communication protocols, including future standards or variations thereof.

In accordance with various implementations, the BS 202 may be an evolved node B (eNB), a serving eNB, a target eNB, a femto station, or a pico station, for example. In some implementations, the UE 204 can be various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the implementations disclosed herein may be implemented directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some implementations, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the BS 202 that enable bi-directional communication between BS transceiver 210 and other network components and communication nodes configured to communication with the BS 202. For example, network communication module 218 may be configured to support internet or WiMAX traffic. In a typical deployment, without limitation, network communication module 218 provides an 802.3 Ethernet interface such that BS transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

Some arrangements described herein relate to configuring or indicating dynamic switching of uplink transmission parameters (e.g., transform precoder configuration) for an uplink transmission (e.g., PUSCH) scheduled by Random Access Response (RAR) Uplink (UL) grant or Downlink Control Information (DCI) format 0-0 with Cyclic Redundancy Check (CRC) scrambled by Temporary Cell Radio Network Temporary Identifier (TC-RNTI). Further, a time-domain requirement related to PUSCH using different transmission parameters (e.g., transform precoder configuration) can be defined. Dynamic switching and selection of uplink transmission parameters (e.g., transform precoder configuration) can thus be supported to flexibly match the requirements of coverage enhancement and improve network capacity.

In some examples, the codeword of CP-OFDM has two inputs and the codeword of DFT-s-OFDM has one input. With regard to whether transform precoder is executed before precoding, the transform precoder exists under DFT-s-OFDM, while no transform precoder is used in connection with CP-OFDM.

In some examples, in response to the UE receiving RRC signaling including an indication corresponding to the transform precoder being set to disabled (e.g., the RRC parameter transformPrecoder being set to disabled), the UE uses CP-OFDM for transmitting PUSCH transmission to the network (e.g., a BS), given that CP-OFDM does not utilize a transform precoder. On the other hand, in response to the UE receiving RRC signaling including an indication corresponding to the transform precoder being set to enabled (e.g., the RRC parameter transformPrecoder being set to enabled), the UE uses DFT-s-OFDM for transmitting PUSCH transmission to the network (e.g., a BS).

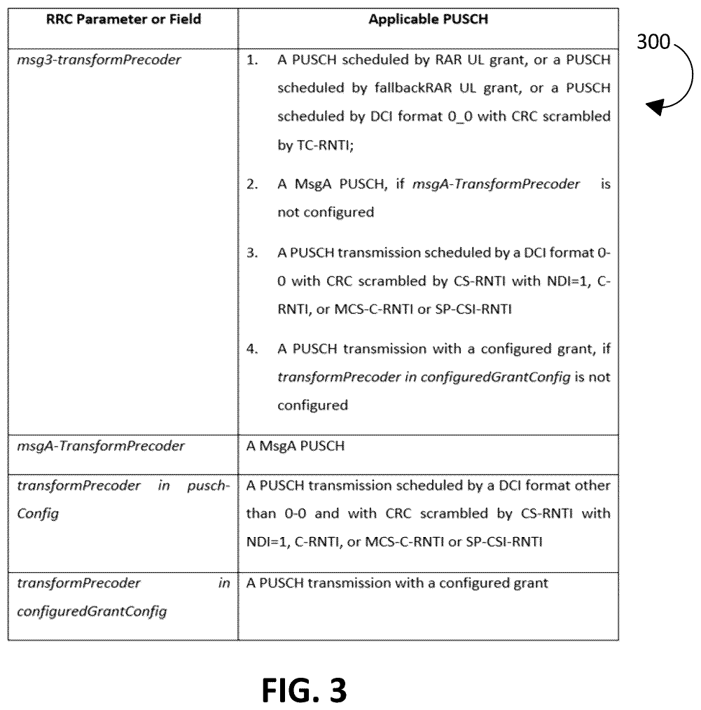

FIG. 3 is a table 300 illustrating example relationships between RRC parameters or fields and applicable PUSCH, according to some arrangements. As shown in table 300, 4 RRC parameters each corresponding to a transform precoder can be configured by the network (e.g., by a BS) for indicating the transmission parameter (e.g., transform precoder configuration) for different types of PUSCHs. For example, the parameter msg3-transformPrecoder applies to 1) a PUSCH scheduled by Random Access Response (RAR) UL grant, or a PUSCH scheduled by fallback RAR UL grant, or a PUSCH scheduled by DCI format 0_0 with CRC scrambled by TC-RNTI; 2) a MsgA PUSCH, if msgA-TransformPrecoder is not configured; 3) a PUSCH transmission scheduled by a DCI format 0-0 with CRC scrambled by CS-RNTI with New Data Indicator (NDI)=1, C-RNTI, or Modulation Coding Scheme Cell RNTI (MCS-C-RNTI) or Semi-Persistent Channel State Information (CSI) RNTI (SP-CSI-RNTI); or 4) a PUSCH transmission with a configured grant, if transformPrecoder in configuredGrantConfig is not configured. The parameter msgA-TransformPrecoder applies to a MsgA PUSCH. The parameter transformPrecoder in pusch-Config applies to a PUSCH transmission scheduled by a DCI format other than DCI format 0-0 and with CRC scrambled by CS-RNTI with NDI=1, C-RNTI, MCS-C-RNTI, or SP-CSI-RNTI. The parameter transformPrecoder in configuredGrantConfig applies to a PUSCH transmission with a configured grant.

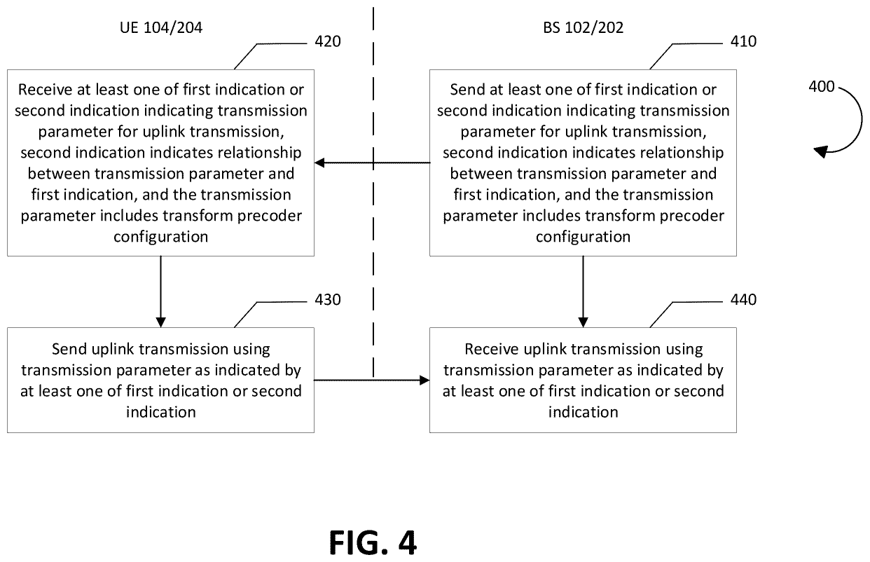

FIG. 4 is a flowchart diagram illustrating an example method 400 for performing transmission parameters (e.g., transform precoder configuration) switching, according to various arrangements. Referring to FIGS. 1-4, the method 400 can be performed by a network and the UE 104/204. As used herein, the network refers to network entities (e.g., the BS 102/202) other than the UE 104/204.

In some arrangements, the network (e.g., a BS) sends to the UE a first indication that indicates transmission parameters (e.g., transform precoder configuration, or a transmission waveform configuration) for sending uplink transmission. The UE receives from the network the first indication that indicates transmission parameters (e.g., transform precoder configuration, or a transmission waveform configuration) for sending the uplink transmission. In some examples, the waveform includes one of a waveform supporting single-layer transmissions (e.g., E.g., DFT-s-OFDM) or a waveform supporting multi-layer transmissions (e.g., CP-OFDM). In some arrangements, the UE sends to the network, the uplink transmission using the transmission parameter in response to receiving the first indication. The network receives the uplink transmission using the transmission parameter in response to the first indication.

In some arrangements, the network (e.g., a BS) indicates to or configures for a UE dynamic switching of uplink transmission parameters (e.g., transform precoder configuration). In some examples, the network can indicate or configure the dynamic switching of uplink transmission parameters (e.g., transform precoder configuration) using RRC signaling. For instance, the network sends and the UE receives a second indication that indicates dynamic switching of transmission parameters (e.g., transform precoder configuration).

In some examples, a parameter or field of an indication for transform precoder (e.g., msg3-transformPrecoder) includes to three statuses. Specifically, a new value that indicates that whether the transform precoder is enabled depending on dynamic indication is provided. Accordingly, the transform precoder indication includes three values that correspond to three statuses, including transform precoder being enabled, transform precoder being disabled, and transform precoder configuration depending on dynamic indication. Another parameter or field for another type of transform precoder indication (e.g., msgA-TransformPrecoder, transformPrecoder in pusch-Config, and transformPrecoder in configuredGrantConfig) can similarly include the value corresponding to the status that transform precoder configuration depends on dynamic indication (e.g., the first indication). Accordingly, the second indication is a RRC signaling. The second indication is set to one of a first value indicating that a transform precoder is enabled, a second value indicating that the transform precoder is disable, or a third value indicating that the transform precoder is enabled or disabled based on the first indication.

In some examples, either of the statuses the transform precoder being enabled or the transform precoder being disabled can be defined as a default status in the example in which the second indication (e.g., corresponding the transform precoder being enabled based on the first indication/dynamic switching) is absent. For example, if the parameter or field corresponding to the transform precoder indication is absent, the UE can determine that the transform precoder is either enabled or disabled according to dynamic indication (e.g., the first indication). Accordingly, a transform precoder indication is a parameter in RRC signaling. If the transform precoder indication is absent, the transform precoder is enabled or disabled based on the first indication (e.g., dynamic indication).

In some examples, a new RRC parameter or field can be defined to have the following structure:

dynamicTransformPrecoder ENUMERATED {ture} (1)

The presence of the new RRC parameter or field indicates that the transform precoder is either enabled or disabled according to dynamic indication (e.g., the first indication). The absence of the new RRC parameter or field indicates that the UE determines that the transform precoder as either enabled or disabled according to RRC configuration e.g., via either one msg3-transformPrecoder, msgA-transformPrecoder and transformPrecoder. Accordingly, in some examples, the second indication is RRC signaling. Presence of the second indication indicates that a transform precoder is enabled or disabled based on the first indication (e.g., dynamic switching). Absence of the second indication indicates that the transform precoder is enabled or disabled based on at least another parameter in the RRC signaling (e.g., either one existing RRC signaling, msg3-transformPrecoder, msgA-transformPrecoder and transformPrecoder).

In some examples, a legacy UE or a UE which does not support to dynamic switch the transform precoder configuration can omit the new RRC parameter or field. The UE can determine a transform precoder configuration or waveform for uplink transmissions according to the RRC configuration via e.g., either one msg3-transformPrecoder, msgA-transformPrecoder and transformPrecoder.

In some arrangements, the network (e.g., a BS) indicates to or configures for a UE dynamic switching of uplink waveforms or transform precoder configuration. The network can provide waveform indication or transform precoder configuration using DCI format for uplink scheduling. For example, the first indication communicated in blocks 410 and 420 includes a transform precoder indicator field of a DCI format 0_0. Specifically, the DCI format 0-0 includes an 1-bit transform precoder indicator field to indicate whether to a switching is needed (e.g., 0 means no switch and 1 means switch) or which waveform or transform precoder configuration to be used (e.g., 0 means a first waveform is to be used (e.g., transform precoder is enabled) and 1 means a second waveform is to be used (e.g., transform precoder is disabled)).

In some arrangements, the transform precoder indicator field is introduced or present in the DIC format 0_0 in response to determining one or more of: 1) UE has the capability of uplink transmission parameter dynamic switching (e.g., between CP-OFDM and DFT-s-OFDM, enable or disable the transform precoder); 2) the number of bits for DCI format 1_0 before padding is greater than the number of bits for DCI format 0_0 before padding; 3) the number of bits for DCI format 1_0 before padding is greater than the number of bits for DCI format 0_0 before padding by more than 1 bit; or 4) the number of bits for DCI format 1_0 before padding is greater than the number of bits for DCI format 0_0 before padding by more than 1 bit if uplink/supplemental uplink indicator field is present in DCI format 0_0, and the number of bits for DCI format 1_0 before padding is greater than the number of bits for DCI format 0_0 if uplink/supplemental uplink indicator field is absent in DCI format 0_0.

In some examples, the transform precoder indicator field, if present, is located in the last bit of the DCI format 0_0, after the padding bit(s) of the DCI format 0_0. In some examples, the transform precoder indicator field, if present, is located in the penultimate bit of DCI format 0_0, after the padding bit(s) of the DCI format 0_0. In some examples, the transform precoder indicator field, if present, is located in the last bit of DCI format 0_0, after the padding bit(s) of the DCI format 0_0, if uplink/supplemental uplink indicator field is absent in DCI format 0_0. In some examples, the transform precoder indicator field, if present, is located in the penultimate bit of DCI format 0_0, after the padding bit(s) of the DCI format 0_0, if uplink/supplemental uplink indicator field is present in DCI format 0_0.

In some arrangements, the first indication includes a transform precoder indicator field, and a DCI format for scheduling the uplink transmission includes the transform precoder indicator field in response to determining the transmission parameter is indicated by the first indication according to the second indication. In some examples, if the number of bits for DCI format 1_0 before padding is greater than the number of bits for DCI format 0_0 before padding by only 1 bit, the extra bit of DCI format 1_0 can be used as uplink/supplemental uplink indicator. In some arrangements, this extra bit of DCI format 1_0 can be used as transform precoder indicator field. In some arrangements, this extra bit of DCI format 1_0 can be used as either uplink/supplemental uplink indicator or the transform precoder indicator according to RRC configuration.

For example, this extra bit of DCI format 1_0 is used as uplink/supplemental uplink indicator if the cell has two uplink carriers and the UE does not have the capability of uplink transmission parameter (e.g., transform precoder) dynamic switching. In some examples, this extra bit of DCI format 1_0 is used as transform precoder indicator if the cell does not have two uplink carriers and the UE has the capability of uplink transmission parameter (e.g., transform precoder) dynamic switching. In some examples, this extra bit of DCI format 1_0 is used as transform precoder indicator if the UE has the capability of uplink transmission parameter (e.g., transform precoder) dynamic switching. In some examples in which the above conditions cannot be satisfied, the network does not provide any uplink transmission parameter dynamic switching indication, or the indication field is 0 bit. Then, the uplink transmission parameter (e.g., transform precoder) can be determined according to RRC configuration or a predefined uplink transmission parameter.

For DCI format 0-1, if transform precoder configuration of uplink transmission is determined depending on dynamic indication as configured by RRC signaling, the size of DCI format 0-1 is determined by assuming transform precoder is disabled via RRC signaling. In other words, a size of the DCI format including the transform precoder indicator field is determined based on a size of the same DCI format under the case that the transform precoder is disabled via RRC signaling. The size of the DCI format includes the transform precoder indicator field is same as the size of the same DCI format, where the transform precoder is disabled via RRC signaling, in some examples. In some examples, the size of the DCI format including the transform precoder indicator field is larger than the size of the same DCI format under, where the transform precoder is disabled via RRC signaling by 1 bit.

Similarly, for DCI format 0-2, if transform precoder configuration of uplink transmission is determined depending on dynamic indication as configured by RRC signaling, the size of DCI format 0-2 is determined by assuming transform precoder is disabled via RRC signaling. In other words, the UE receives the second indication via RRC that indicates dynamic switching of transform precoder configurations, and a size of DCI format 0_2 is determined based on transform precoder is disabled via RRC.

More specifically, in some arrangements, the size of each field in DCI format 0-1/0-2 is the same regardless of whether the transform precoder configuration of uplink transmission is determined dynamically or transform precoder is disabled via RRC signaling. In other arrangements, the total size of DCI format 0-1/0-2 is aligned between the case in which transform precoder configuration of uplink transmission being determined dynamically and transform precoder being disabled via RRC signaling. For the fields in which size is related with whether transform precoder is enabled or disabled, the size of such fields can be different between the cases of transform precoder configuration of uplink transmission being determined dynamically and transform precoder being disabled via RRC signaling. The size of these fields can be determined according to the transform precoder indicator field. Padding bits will be added if transform precoder is disabled by the transform precoder indicator field.

Some arrangements relate to configuring or indicating dynamic switching of transform precoder configuration for PUSCH scheduled by Random Access Response (RAR) uplink grant. In some examples in which the uplink transmission (e.g., the PUSCH) is scheduled by RAR UL grant (which can also be referred to as msg.3 PUSCH), the transform precoder configuration can be dynamically indicated.

In some arrangements, the UE is configured with the specific PRACH resources (e.g., RACH occasion, preamble index) corresponding to the msg.3 PUSCH with transform precoder is enabled, e.g., DFT-s-OFDM waveform. When the UE uses one of these specific PRACH resources to initiate the random access process, the transform precoder will be enabled for subsequent msg.3 PUSCH, e.g., using DFT-s-OFDM waveform.

On the other hands, the UE is configured with the specific PRACH resources (e.g., RACH occasion, preamble index) corresponding to the msg.3 PUSCH with transform precoder is disabled, e.g., CP-OFDM waveform. When the UE uses one of these specific PRACH resources to initiate the random access process, the transform precoder will be disabled for subsequent msg.3 PUSCH, e.g., using CP-OFDM waveform.

Thus, in some examples, the uplink transmission in the method 400 is scheduled by an RAR uplink grant. The second indication includes configuration of resources for a random access procedure corresponding to a transmission parameter of the uplink transmission. The UE initiates the random access procedure using the resources for the random access procedure. The uplink transmission with the transmission parameter is sent subsequent to initiating the random access procedure.

In some arrangements, a Reference Signal Received Power (RSRP) threshold can be defined. For example, in response to determining that the result of Synchronization Signal/Physical Broadcast Channel (PBCH) Block SSB based RSRP measurement lower than the RSRP threshold, the UE can use PRACH resources corresponding to the msg.3 PUSCH with transform precoder is enabled (e.g., DFT-s-OFDM waveform). Otherwise, in response to the UE selecting a PRACH resource outside of the specific PRACH resources, the transmission parameter (e.g., whether to enable the transform precoder) can be determined according to RRC configuration, e.g., msg3-transformPrecoder.

In some arrangements, the UE is configured with the specific PRACH resources (e.g., RACH occasion, preamble index) corresponding to the msg.3 PUSCH repetition or PRACH repetition. When the UE uses one of these specific PRACH resources to initiate the random access process, the transform precoder will be enabled for subsequent msg.3 PUSCH, e.g., using DFT-s-OFDM waveform.

In some arrangements, the UE is configured with the specific PRACH resources (e.g., RACH occasion, preamble index) corresponding to the msg.3 PUSCH repetition. When the UE uses one of these specific PRACH resources to initiate the random access process and the base station indicates the msg.3 PUSCH transmission with repetition, the transform precoder will be enabled for subsequent msg.3 PUSCH, e.g., using DFT-s-OFDM waveform.

Thus, in some examples, the uplink transmission in the method 400 is scheduled by an RAR uplink grant. The second indication includes configuration of resources for a random access procedure corresponding to at least one repetition of the uplink transmission or at least one repetition of a preamble of the random access procedure. The UE initiates the random access procedure using the resources for the random access procedure. The uplink transmission with the transform precoder enabled is sent subsequent to initiating the random access procedure.

Otherwise, in response to the UE selecting a PRACH resource outside of the specific PRACH resources, the transmission parameter (e.g., whether to enable the transform precoder) is be determined according to RRC configuration, e.g., msg3-transformPrecoder. Or the uplink transmission with the transform precoder disabled is sent subsequent to initiating the random access procedure.

In some arrangements, the UE is configured with the specific PRACH resources (e.g., RACH occasion, preamble index) corresponding to dynamic switching of transmission parameter of the msg.3 PUSCH. When the UE uses one of these specific PRACH resources to initiate the random access process, the subsequent msg.3 PUSCH is transmitted using a transmission parameter indicated in the RAR uplink grant. Thus, in some examples, the uplink transmission in the method 400 is scheduled by an RAR uplink grant. The second indication includes configuration of resources for a random access procedure corresponding to transform precoder being enabled or disabled for the uplink transmission. The random access procedure is initiated using the resources for the random access procedure. The transform precoder configuration of the uplink transmission subsequent to initiating the random access procedure is indicated in the first indication. In some examples, the transform precoder configuration is introduced in the Time Domain Resource Assignment (TDRA) table as a column, TDRA field in the RAR uplink grant will be used for indicating time domain resource allocation and transform precoder configuration for msg.3 PUSCH transmission. In some embodiments, N Most Significant Bits (MSBs) or Last Significant Bit (LSBs) of a specific field in RAR UL grant can be used for indicating the transform precoder configuration for msg.3 PUSCH. The specific field can be one of, Modulation Coding Scheme (MCS) field, TDRA field, Transmit Power Control (TPC) field, or so on.

In some arrangements in which a UE transmits the PRACH with repetition, the transform precoder can be enabled for subsequent msg.3 PUSCH, e.g., using DFT-s-OFDM waveform. Otherwise, if a UE transmit PRACH without repetition, the transform precoder configuration used for msg.3 PUSCH transmission is determined according to RRC configuration, e.g., msg3-transformPrecoder. In some arrangements, the uplink transmission with the transform precoder disabled is sent subsequent to initiating the random access procedure. In some examples, the uplink transmission is scheduled by an RAR uplink grant, and the transform precoder is enabled for the uplink transmission if the UE transmits a preamble for a random access procedure with repetition.

In some arrangements, the transform precoder configuration of PUSCH scheduled by RAR UL grant is the same as that of PUSCH scheduled by a latest DCI (e.g., the most recent DCI immediately preceding RAR UL grant). In some examples, the uplink transmission is scheduled by a RAR uplink grant, and the same transform precoder configuration is used as that of an uplink transmission scheduled by a latest DCI.

In some arrangements, the transform precoder configuration of PUSCH scheduled by RAR UL grant or DCI format 0_0 is the same as that of PUSCH scheduled by a latest DCI with DCI format 0_1 or 0_2.

In some arrangements, the transform precoder configuration of a configured grant PUSCH is the same as that of PUSCH scheduled by a latest DCI before the configured grant PUSCH. In some examples, the latest DCI has DCI format 0_1 or 0_2. In some examples, the latest DCI can be either of DCI format 0_0, 0_1 or 0_2.

Some arrangements relate to configuring or indicating dynamic switching of uplink transmission parameter (e.g., transform precoder configuration) for PUSCH scheduled by DCI format 0-0 with CRC scrambled by TC-RNTI. In some arrangements, the transform precoder configuration used for the PUSCH scheduled by DCI format 0-0 with CRC scrambled by TC-RNTI is the same as that for initial transmission of msg.3 PUSCH, which is scheduled by RAR UL grant. In some arrangements, the transform precoder configuration used for the PUSCH scheduled by DCI format 0-0 with CRC scrambled by TC-RNTI follows the transform precoder configuration of PUSCH scheduled by DCI format 0-0 with CRC scrambled by C-RNTI. In some arrangements, the transform precoder configuration used for the PUSCH scheduled by DCI format 0-0 with CRC scrambled by TC-RNTI follows configuration of msg3-transformPrecoder.

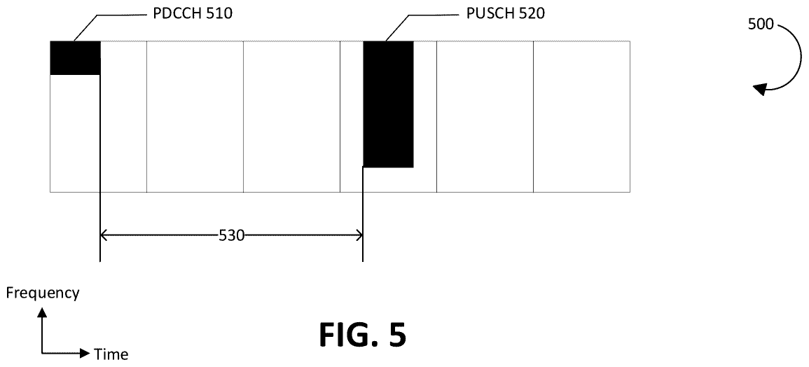

FIG. 5 is a diagram illustrating time-domain restrictions for dynamic switching of uplink transmission parameters, according to various arrangements. In FIG. 5, the vertical dimension denotes the frequency domain and the horizontal dimension denotes the time domain. Time-frequency resources 500 are shown as blocks, each of which may correspond to a slot. In some arrangements, time-domain restriction can be defined in dynamic switching of uplink transmission parameters. In some arrangements, two timelines between uplink grant (e.g., received in PDCCH 510) and corresponding PUSCH 520 scheduled by the uplink grant can be defined. In the example in which the UE reports its capability for supporting uplink transmission parameter (e.g., transform precoder configuration) dynamic switching or uplink transmission parameter (e.g., transform precoder configuration) dynamic switching is configured via RRC signaling, a timeline 530 with a longer time period is determined. In the example in which the UE does not support uplink transmission parameter (e.g., transform precoder configuration) dynamic switching or the uplink transmission parameter (e.g., transform precoder configuration) dynamic switching is not configured via RRC signaling, a timeline with shorter time period will be used. The timeline is defined as the length of time between the PDCCH 510 carrying the uplink grant and the PUSCH 520. In other words, the UE receives from the network an uplink grant scheduling the uplink transmission. A length of time between the uplink grant and the uplink transmission is determined based on whether the UE supports dynamic switching of transform precoder configuration.

In some arrangements, two timelines between the uplink grant 510 and corresponding PUSCH 520 can be defined. If the PUSCH 520 is indicated to use a different uplink transmission parameter (e.g., transform precoder configuration) from that of the latest PUSCH (not shown), which is the PUSCH immediately preceding the PUSCH 520, a timeline with a longer length of time is adopted. Otherwise, if the PUSCH 520 is indicated to use a same uplink transmission parameter (e.g., transform precoder configuration) as that of the latest PUSCH, another timeline with shorter time length of time is adopted. In other words, the UE receives from the network an uplink grant scheduling the uplink transmission. A length of time between the uplink grant and the uplink transmission is determined based on whether the uplink grant is indicated using a same transform precoder configuration as a transform precoder configuration of a latest uplink transmission.

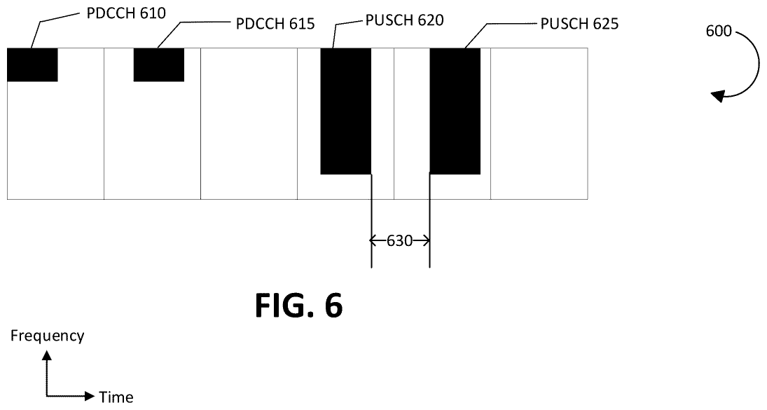

FIG. 6 is a diagram illustrating time-domain restrictions for dynamic switching of uplink transmission parameters (e.g., transform precoder configuration), according to various arrangements. In FIG. 6, the vertical dimension denotes the frequency domain and the horizontal dimension denotes the time domain. Time-frequency resources 600 are shown as blocks, each of which may correspond to a slot. The uplink grant for PUSCH 620 is received in PDCCH 610. The uplink grant for PUSCH 625 is received in PDCCH 615. In some arrangements, if two PUSCHs 620 and 625 are indicated to correspond to different transmission parameters (e.g., transform precoder configuration), a time-domain gap 630 with N symbols between PUSCHs 620 and 625 is needed. In other words, if two PUSCHs 620 and 625 with different transmission parameters (e.g., transform precoder configuration) are scheduled for a UE, the UE does not expect the gap 630 between two PUSCHs 620 and 625 to be lesser than a predefined threshold, where the predefined threshold is N symbols. That is, the UE receives from the network a first uplink grant scheduling a first uplink transmission. The UE receives from the network a second uplink grant scheduling a second uplink transmission. The second uplink transmission is indicated to correspond to a transform precoder configuration different from that of the first uplink transmission. A gap between the first uplink transmission and the second uplink transmission is greater than a threshold.

Accordingly, configuration and indication of dynamic switching of uplink transmission parameter (e.g., transform precoder configuration) for a PUSCH scheduled by RAR UL grant or DCI format 0-0 with CRC scrambled by TC-RNTI can be implemented. Further, a time-domain requirement related with PUSCH using different transmission parameter (e.g., transform precoder configuration) can be defined. The arrangements disclosed herein can effectively support dynamic switching and selection of uplink transmission parameter (e.g., transform precoder configuration), and flexibly match the requirements of coverage enhancement and capacity increase.

While various implementations of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one implementation can be combined with one or more features of another implementation described herein. Thus, the breadth and scope of the present disclosure should not be limited by any of the above-described illustrative implementations.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according implementations of the present solution.

Additionally, memory or other storage, as well as communication components, may be employed in implementations of the present solution. It will be appreciated that, for clarity purposes, the above description has described implementations of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed is:

1. A wireless communication method, comprising:
receiving, by a wireless communication device from a network, at least one of a first indication or a second indication, the at least one of the first indication or second indication indicates a transmission parameter for uplink transmission, wherein the second indication indicates that a relationship between the transmission parameter and the first indication, and the transmission parameter comprises transform precoder configuration; and
sending, by the wireless communication device to the network, the uplink transmission using the transmission parameter as indicated by the at least one of the first indication or the second indication.

2. The method of claim 1, wherein:
the second indication is a Radio Resource Control (RRC) signaling;
the second indication is set to one of a first value indicating that a transform precoder is enabled, a second value indicating that the transform precoder is disable, or a third value indicating that the transform precoder is enabled or disabled based on the first indication.

3. The method of claim 1, wherein:
the second indication is a Radio Resource Control (RRC) signaling;
presence of the second indication indicates that a transform precoder is enabled or disabled based on the first indication;
absence of the second indication indicates that the transform precoder is enabled or disabled based on at least another parameter in the RRC signaling.

4. The method of claim 1, wherein the first indication comprises a transform precoder indicator field of a Downlink Control Information (DCI) format 0_0.

5. The method of claim 4, wherein the transform precoder indicator field is present in DCI format 0_0 in response to determining at least one of:
the wireless communication device has capability of uplink transmission parameter dynamic switching;
a number of bits of DCI format 1_0 before padding is greater than a number of bits for DCI format 0_0 before padding; or the number of bits of DCI format 1_0 before padding is larger than the number of bits for DCI format 0_0 before padding by more than 1 bit.

6. The method of claim 4, wherein the transform precoder indicator field is located in one of:
a last bit of the DCI format 0_0 after padding bits of the DCI format 0_0;
a penultimate bit of the DCI format 0_0 after padding the bits of the DCI format 0_0;
the last bit of the DCI format 0_0 after padding bits of the DCI format 0_0 if uplink/supplemental uplink indicator field is absent; or the penultimate bit of the DCI format 0_0 after padding the bits of the DCI format 0_0 if the uplink/supplemental uplink indicator field is present.

7. The method of claim 1, wherein:
the first indication comprises a transform precoder indicator field, and a Downlink Control Information (DCI) format for scheduling the uplink transmission comprises the transform precoder indicator field in response to determining the transmission parameter is indicated by the first indication according to the second indication.

8. The method of claim 7, wherein a size of the DCI format comprising the transform precoder indicator field is determined based on a size of the same DCI format wherein the transform precoder is disabled via RRC signaling.

9. The method of claim 8, wherein:
the size of the DCI format comprising the transform precoder indicator field is same as the size of the same DCI format wherein the transform precoder is disabled via Radio Resource Control (RRC) signaling; or
the size of the DCI format comprising the transform precoder indicator field is larger than the size of the same DCI format wherein the transform precoder is disabled via RRC signaling by 1 bit.

10. The method of claim 1, wherein:
the uplink transmission is scheduled by a Random Access Response (RAR) uplink grant;
the second indication comprises configuration of resources for a random access procedure corresponding to a transmission parameter of the uplink transmission;
the method comprises initiating the random access procedure using the resources for the random access procedure; and
the uplink transmission with the transmission parameter is sent subsequent to initiating the random access procedure.

11. The method of claim 1, wherein:
the uplink transmission is scheduled by a Random Access Response (RAR) uplink grant;
the second indication comprises configuration of resources for a random access procedure corresponding to at least one repetition of the uplink transmission or at least one repetition of a preamble of the random access procedure;
the method comprises initiating the random access procedure using the resources for the random access procedure; and
the uplink transmission with transform precoder enabled is sent subsequent to initiating the random access procedure.

12. The method of claim 1, wherein:
the uplink transmission is scheduled by a Random Access Response (RAR) uplink grant;
the second indication comprises configuration of resources for a random access procedure corresponding to transform precoder being enabled or disabled for the uplink transmission;
the method comprises initiating the random access procedure using the resources for the random access procedure; and
the transform precoder configuration of the uplink transmission subsequent to initiating the random access procedure is indicated in the first indication.

13. The method of claim 12, wherein:
the transform precoder configuration is indicated in a column in a Time Domain Resource Assignment (TDRA) table of the RAR uplink grant; or
the transform precoder configuration is indicated in a field of the RAR uplink grant.

14. The method of claim 1, wherein:
the uplink transmission is scheduled by a Random Access Response (RAR) uplink grant; and
the transform precoder is enabled for the uplink transmission if the wireless communication device transmits a preamble for a random access procedure with repetition.

15. The method of claim 1, wherein:
the uplink transmission is scheduled by a Random Access Response (RAR) uplink grant; and
the same transform precoder configuration is used as that of an uplink transmission scheduled by a latest Downlink Control Information (DCI).

16. The method of claim 1, wherein:
the uplink transmission is scheduled by a Downlink Control Information (DCI) format 0-0 with Cyclic Redundancy-Check (CRC) scrambled by Temporary Cell (TC)-Radio Network Temporary Identifier (RNTI);
the transform precoder configuration is one of:
a transform precoder configuration of an initial transmission of the uplink transmission scheduled by a Random Access Response (RAR) uplink grant;
a transform precoder configuration of an uplink transmission scheduled by DCI format 0-0 with CRC scrambled by Cell RNTI (C-RNTI); or
a transform precoder configuration determined according to configuration of msg3-transformPrecoder.

17. The method of claim 1, further comprising receiving, by the wireless communication device from the network, an uplink grant scheduling the uplink transmission, wherein a length of time between the uplink grant and the uplink transmission is determined based on whether the wireless communication device supports dynamic switching of transform precoder configurations.

18. A wireless communication device, comprising:
at least one processor configured to:
receive, via a transceiver from a network, at least one of a first indication or a second indication, the at least one of the first indication or second indication indicates a transmission parameter for uplink transmission, wherein, the second indication indicates that a relationship between the transmission parameter and the first indication, and the transmission parameter comprises transform precoder configuration; and
send, via a transceiver to the network, the uplink transmission using the transmission parameter as indicated by the at least one of the first indication or the second indication.

19. A wireless communication method, comprising:
sending, by a network to a wireless communication device, at least one of a first indication or a second indication, the at least one of the first indication or the second indication indicating that a transmission parameter for uplink transmission, wherein, the second indication indicates that the relationship between the transmission parameter and the first indication, and the transmission parameter comprises transform precoder configuration; and
receiving, by the network from the wireless communication device, the uplink transmission using the transmission parameter as indicated by the at least one of the first indication or the second indication.

20. A network node, comprising:
at least one processor configured to:
send, via a transceiver to a wireless communication device, at least one of a first indication or a second indication, the at least one of the first indication or the second indication indicating that a transmission parameter for uplink transmission, wherein, the second indication indicates that the relationship between the transmission parameter and the first indication, and the transmission parameter comprises transform precoder configuration; and
receive, via the transceiver from the wireless communication device, the uplink transmission using the transmission parameter as indicated by the at least one of the first indication or the second indication.
